(19) United States
(12) Patent Application Publication
(10) Pub. No.: US 2014/0178770 A1
(43) Pub. Date: Jun. 26, 2014

(54) ELECTROLYTES FOR DENDRITE-FREE ENERGY STORAGE DEVICES HAVING HIGH COULOMBIC EFFCIENCY

(71) Applicant: Battelle Memorial Institute, Richland, WA (US)

(72) Inventors: Wu Xu, Richland, WA (US); Ji-Guang Zhang, Richland, WA (US); Yaohui Zhang, Harbin (CN); Xilin Chen, Richland, WA (US)

(73) Assignee: Battelle Memorial Institute

(21) Appl. No.: 14/192,808

(22) Filed: Feb. 27, 2014

Related U.S. Application Data
(63) Continuation-in-part of application No. 13/495,727, filed on Jun. 13, 2012.
Application No. 13/495,727 is a continuation-in-part of application No. 13/367,508, filed on Feb. 7, 2012, now abandoned.
Application No. 13/367,508 is a continuation-in-part of application No. 13/495,745, filed on Jun. 13, 2012.
Application No. 13/495,745 is a continuation-in-part of application No. 13/367,508, filed on Feb. 7, 2012, now abandoned.
(60) Provisional application No. 61/773,364, filed on Mar. 6, 2013.

(51) Int. Cl. H01M 10/0567; H01M 10/0569

(52) U.S. Cl. CPC H01M 10/0567; H01M 10/0569
USPC 429/331; 429/188; 429/342; 429/338; 429/341; 429/343; 429/340; 429/339; 429/336; 429/199; 429/332

(57) ABSTRACT

The Coulombic efficiency of lithium deposition/stripping can be improved while also substantially preventing lithium dendrite formation and growth using particular electrolyte compositions. Embodiments of the electrolytes include organic solvents and their mixtures to form high-quality SEI layers on the lithium anode surface and to prevent further reactions between lithium and electrolyte components. Embodiments of the disclosed electrolytes further include additives to suppress dendrite growth during charge/discharge processes. The solvent and additive can significantly improve both the Coulombic efficiency and smoothness of lithium deposition. By optimizing the electrolyte formulations, practical rechargeable lithium energy storage devices with significantly improved safety and long-term cycle life are achieved. The electrolyte can also be applied to other kinds of energy storage devices.

### CROSS-REFERENCE TO RELATED APPLICATIONS

This application claims the benefit of U.S. Provisional Patent Application No. 61/773,364, filed Mar. 6, 2013, and is a continuation-in-part of currently pending U.S. patent application Ser. No. 13/495,727, filed Jun. 13, 2012, and U.S. patent application Ser. No. 13/495,745, filed Jun. 13, 2012, both of which are continuations-in-part of currently pending U.S. patent application Ser. No. 13/367,508, filed Feb. 7, 2012, now abandoned, all of which are incorporated herein by reference.

### STATEMENT REGARDING FEDERALLY SPONSORED RESEARCH OR DEVELOPMENT

This invention was made with Government support under Contract DE-AC05576RLO1830 awarded by the U.S. Department of Energy. The Government has certain rights in the invention.

### BACKGROUND

Electrodeposition is widely used to coat a functional material having a desired property onto a surface that otherwise lacks that property. During electrodeposition, electrically charged reactants in an electrolyte solution diffuse, or are moved by an electric field, to cover the surface of an electrode. For example, the electrical current can reduce reactant cations to yield a deposit on an anode. Or, anions of reactants in the electrolyte solution can diffuse, or be moved by the electric field, to cover the surface of a cathode, where the reactant anions are oxidized to form a deposit on the electrode.

Electrodeposition has been successfully utilized in the fields of abrasion and wear resistance, corrosion protection, lubricity, aesthetic qualities, etc. It also occurs in the operation of certain energy storage devices. For example, in the charge process of a metal battery or metal-ion battery, metal ions in the electrolyte move from the cathode and are deposited on the anode. Some organic compounds with unsaturated carbon-carbon double or triple bonds are used as additives in non-aqueous electrolytes and are electrochemically reduced and deposited at the anode surface or oxidized and deposited at the cathode surface to form solid electrolyte interphase layers as protection films on both anode and cathode of lithium batteries. Some other organic compounds with conjugated bonds in the molecules are electrochemically oxidized and deposited at the cathode surface to form electric conductive polymers as organic cathode materials for energy storage devices.

In most instances, the ideal is a smooth electrodeposited coating. For example, a smoothly plated film can enhance the lifetime of a film used for decoration, wear resistance, corrosion protection, and lubrication. A smoothly plated film is also required for energy storage devices, especially for secondary devices. Rough films and/or dendrites generated on electrode surfaces during the charge/discharge processes of these energy storage devices can lead to the dangerous situations, short-circuits, reduced capacities, and/or shortened lifetimes. Roughness and/or dendrites can be caused by several reasons, including the uneven distribution of electric current density across the surface of the electrodeposition substrate (e.g., anode) and the uneven reactivity of electrodeposited material and/or substrate to electrolyte solvents, reactants, and salts. These effects can be compounded in the particular case of repeated charging-discharging cycles in energy storage devices. Therefore, a need for improved electrolytes and methods for electrodeposition are needed to enhance the smoothness of the resultant film.

In addition to the dendrite growth during electrochemical deposition of metals, low Coulombic efficiency encountered during the repeated metal deposition/stripping processes is another critical barrier which prevented metal electrode to be used in many practical electrochemical devices such as rechargeable batteries, supercapacitors, sensors, electrochromic devices etc. Therefore, a good combination of electrolyte solvent, salt, and additives still need to be identified to obtain both dendrite-free morphology and high Coulombic efficiency of metal deposition at the same time, which is required for long term cycling operation of metal electrode used in electrochemical devices.

### SUMMARy

This document describes methods and electrolytes for electrodeposition and for energy storage devices that result in self-healing, instead of self-amplification, of initial protuberant tips that are unavoidable during electrodeposition and operation of energy storage devices. The document also describes electrolytes for dendrite suppression and including selected electrolyte solvents and salt additives to improve the Coulombic efficiency of metal deposition/stripping during repeated cycling processes.

The protuberant tips during metal deposition process can give rise to roughness and/or dendrite formation on the electrodeposition substrate and battery system electrodes. For electrodeposition of a first metal (M1) on a substrate or an anode from one or more cations of M1 in an electrolyte solution, embodiments of the electrolyte solution comprise a soluble, surface-smoothing additive comprising a metal (M2). Cations of M2 have an effective electrochemical reduction potential (ERP) in the solution lower than that of the cations of M1.

As used herein, cations, in the context of M1 and/or M2, refer to atoms or molecules having a net positive electrical charge. In but one example, the total number of electrons in the atom or molecule can be less than the total number of protons, giving the atom or molecule a net positive electrical charge. The cations are not necessarily cations of metals, but can also be non-metallic cations. At least one example of a non-metallic cation is ammonium. Cations are not limited to the +1 oxidation state in any particular instance. In some descriptions herein, a cation can be generally represented as X+, which refers generally to any oxidation state, not just +1.

In another example, the cations of M1 might not technically be cations but are positively charged species such as conductive monomers/polymers. During the electrodeposition of a metal cation, the cation gets the electron at the anode and is reduced to metal. When forming a conductive polymer via electrodeposition, it is the conjugated monomer, which can be neutral but with double or triple bonds, that gets the electrons. The conjugated monomer re-arranges the double or triple bonds among the same molecular structure and forms new bonds among different molecules. The formed polymer is either neutral or positively charged when protons are incorporated onto the polymer moiety.

Examples of M1 metals can include, but are not limited to, elemental metals or alloys containing Li, Na, K, Rb, Cs, Be, Mg, Ca, Sr, Ba, Al, Ga, In, TI, Ge, Sn, Pb, As, Sb, Bi, Se, Te, Bi, Po, Sc, Ti, V, Cr, Mn, Fe, Co, Ni, Cu, Zn, Y, Zr, Nb, Mo, Tc, Ru, Rh, Pd, Ag, Cd, W, Pt, Au, and/or Hg. Preferably, M1 is an elemental metal material comprising Li, Na, Mg, Al, Sn, Ti, Fe, Ni, Cu, Zn, Ag, Pt, or Au. Most preferably, M1 comprises Li.

Examples of metals for cations of M2 include, but are not limited to, Li, Cs, Rb, K, Na, Ba, La, Sr, Ca, Mg, Be, Ra, La, Zr, Te, B, Bi, Ta, Ga, Eu, S, Se, Nb, Cu, Al, Fe, Zn, Ni, Ti, Sn, Sb, Mn, V, Sc, Ta, Cr, Au, Ge, Co, As, Ag, Mo, Si, W, Ru, I, Br, Re, Pt, and/or Pd. In preferred embodiments, cations of M2 are cations of Cs, Rb, K, Ba, Sr, Ca, Li.

A cation of M2 might have a standard reduction potential that is greater than that of the cations of M1. In such instances, some embodiments of the electrolytes have an activity of M2 cations such that the effective ERP of the M2 cations is lower than that of the cations of M1. Because activity is directly proportional to the concentration and activity coefficient, which depend on the mobility and solvation of the cation in the given electrolyte, a lower activity can be a result of low concentration, low activity coefficient of the cations, or both since the activity is the product of the activity coefficient and concentration. The relationship between effective ERP and activity is described in part by the Nernst equation and is explained in further detail elsewhere herein. In a particular embodiment, the concentration of M2 cations is less than, or equal to, 30% (in mole) of that of the cations of M1. In another, the concentration of M2 cations is less than, or equal to, 20% (in mole) of that of the cations of M1. In yet another embodiment, the concentration of M2 cations is less than, or equal to, 10% (in mole) of that of the cations of M1. In yet another embodiment, the concentration of M2 cations is less than or equal to 5% (in mole) of that of the cations of M1.

The surface-smoothing additive can comprise an anion that includes, but is not limited to, PF₆⁻, AsF₆⁻, BF₄⁻, N(SO₂CF₃)2⁻, N(SO₂F)₂⁻, CF₃SO₃⁻, ClO₄⁻, bis(oxalate)borate anion (BOB⁻), difluoro oxalato borate anion (DFOB:), I⁻, Br, Cl⁻, OH⁻, NO₃⁻, SO₄²⁻, and combinations thereof. Preferably, the anion comprises PF₆⁻.

The cations of M2 are preferably not chemically or electrochemically reactive to M1 or the cations of M1, so the additive is not necessarily consumed during electrodeposition or during operation of a battery system.

In one embodiment the electrodeposition anode is an anode in an energy storage device. In particular instances, the anode can comprise lithium, carbon, magnesium, sodium, silicon, silicon oxide, tin, tin oxide, germanium, germanium oxide, phosphorus, antimony or combinations thereof. These materials can also be combined with carbonaceous materials or with carbonaceous material and lithium power. As used herein, an anode is not restricted to a complete structure having both an active material and a current collector. For example, an anode can initially encompass a current collector on which active material is eventually deposited to form the anode. Alternatively, an anode can start out as an active material pasted on a current collector. After initial cycling, the active material can be driven into the current collector to yield what is traditionally referred to as an anode.

Certain embodiments of the present invention encompass energy storage devices that comprise an anode and a M1 metal electrodeposited on the anode during operation of the device. The energy storage device is characterized by an electrolyte solution comprising cations of M1 and by a soluble, surface-smoothing additive comprising an M2 metal cation, wherein cations of M2 have an effective electrochemical reduction potential in solution lower than that of the cations of M1.

In some embodiments the anode comprises carbon. In other embodiments the anode comprises lithium metal. In other embodiments, the anode comprises silicon. Preferably, the M1 metal comprises lithium. Accordingly, in one example, the energy storage device is a lithium ion battery. In another example, the energy storage device is a lithium metal battery.

In some instances, the device further comprises a cathode comprising lithium intercalation compounds. Examples can include, but are not limited to, Li₄₋ₓMₓTi₅O₁₂ (M═Mg, Al, Ba, Sr, or Ta; 0≦x≦1), MnO₂, V₂O₅, LiV₃O₈, LiM^{c1}ₓM^{c2}₁₋ₓPO₄ (M^{c1} or M^{c2}═Fe, Mn, Ni, Co, Cr, or Ti; 0≦x≦1), Li₃V₂₋ₓMₓ(PO₄)₃ (M═Cr, Co, Al, Fe, Mg, Y, Ti, Nb, or Ce; 0≦x≦1), LiVPO₄F, LiM^{c1}ₓM^{c2}₁₋ₓO₂(M^{c1} or M^{c2}═Fe, Mn, Ni, Co, Cr, Ti, Mg, Al; 0≦x≦1), LiM^{c1}ₓM^{c2}_{y}M^{c3}_{1-x-y}O₂ M^{c1}, M^{c2}, or M^{c3}═Fe, Mn, Ni, Co, Cr, Ti, Mg, or Al; 0≦x≦1; 0≦y≦1), LiMn_{2y}X_{y}O₄ (X═Cr, Al, or Fe, 0≦y≦1), LiNi_{0.5-y}X_{y}X_{y}Mn_{1.5}O₄ (X═Fe, Cr, Zn, Al, Mg, Ga, V, or Cu; 0≦y≦0.5), xLi₂MnO₃.(1-x)LiM^{c1}_{y}M^{c2}_{z}M^{c3}_{1-y-z}O₂ (M^{c1}, M^{c2}, or M^{c3}═Mn, Ni, Co, Cr, Fe, or mixture of; x=0.3-0.5; y≦0.5; z≦0.5), Li₂MSiO₄ (M═Mn, Fe, or Co), Li₂MSO₄ (M═Mn, Fe, or Co), LiMSO₄F (Fe, Mn, or Co), Li₂₋ₓ(Fe_{1-y}Mn_{y})P₂O₇ (0≦y≦1).

The M2 metal is preferably selected from the group consisting of Cs, Rb, K, Ba, Sr, Ca, Li, Na, Mg, Al, and combinations thereof. In one embodiment, wherein M1 is Li, the M2 metal is not Na. Examples of surface-smoothing additives can include, but are not limited to, anions comprising PF₆⁻, AsF₆⁻, BF₄⁻, N(SO₂CF₃)₂⁻, N(SO₂F)₂⁻, CF₃SO₃⁻, ClO₄⁻, and combinations thereof.

In some embodiments, the cations of M2 have an activity in solution such that the effective electrochemical reduction potential of M2 is lower than that of the cation of M1. In one example, the cations of M2 have a concentration in the electrolyte solution that is less than, or equal to, 30% (in mole) of that of the cations of M1. In another, the cations of M2 have a concentration in the electrolyte solution that is less than, or equal to, 20% (in mole) of that of the cations of M1. In yet another example, the cations of M2 have a concentration in the electrolyte solution that is less than, or equal to, 5% (in mole) of that of the cations of M1.

According to one embodiment, the energy storage device has an applied voltage less than, or equal to that of the electrochemical reduction potential of the cations of M1 and greater than the effective electrochemical reduction potential of the cations of M2.

In a particular embodiment, an energy storage device comprises an anode and lithium metal electrodeposited on the anode during operation of the device. The energy storage device is characterized by an electrolyte solution comprising Li cations and a soluble, surface-smoothing additive comprising a metal (M2). Cations of M2 have a concentration in solution less than 30% of that of the Li cations and have an effective electrochemical reduction potential in solution lower than that of the Li cations.

The energy storage device can further comprise a separator between the anode and the cathode and the anode can comprise lithium and a non-intercalation carbon layer between the lithium and the separator.

The device can have an applied voltage less than, or equal to, that of the electrochemical reduction potential of the lithium cations and greater than the effective electrochemical reduction potential of the cations of M2.

In some embodiments the solvent is a non-aqueous, aprotic, polar organic substance that dissolves the solute at room temperature. Blends of more than one solvent may be used. Generally, organic solvents can include, but are not limited to, ethers, ketones, carbonates, carboxylates, lactones, phosphates, nitriles, sulfones, sulfoxides, amides, five or six member heterocyclic ring compounds, and organic compounds having at least one M1-C4 group connected through an oxygen atom to a carbon. Lactones may be methylated, ethylated and/or propylated. Other organic solvents can include ethylene carbonate, propylene carbonate, dimethyl carbonate, diethyl carbonate, ethyl methyl carbonate, methyl propyl carbonate, tetrahydrofuran, 2-methyl tetrahydrofuran, 1,3-dioxolane, 1,4-dioxane, 1,2-dimethoxyethane, 1,2-diethoxyethane, 1,2-dibutoxyethane, acetonitrile, dimethylformamide, methyl formate, ethyl formate, propyl formate, butyl formate, methyl acetate, ethyl acetate, propyl acetate, butyl acetate, methyl propionate, ethyl propionate, propyl propionate, butyl propionate, methyl butyrate, ethyl butyrate, propyl butyrate, butyl butyrate, acetone, gamma-butyrolactone, 2-methyl-gamma-butyrolactone, 3-methyl-gamma-butyrolactone, 4-methyl-gamma-butyrolactone, delta-valerolactone, trimethyl phosphate, triethyl phosphate, tris(2,2,2-trifluoroethyl)phosphate, tripropyl phosphate, triisopropyl phosphate, tributyl phosphate, trihexyl phosphate, triphenyl phosphate, tetrahydrofuran, 2-methyl tetrahydrofuran, 1,3-dioxolane, 1,4-dioxane, 1,2-dimethoxyethane, 1,2-diethoxyethane, 1,2-dibutoxyethane, acetonitrile, sulfolane, dimethyl sulfone, ethyl methyl sulfone, dimethylsulfoxide, and combinations thereof.

Methods for improving surface smoothness during electrodeposition of M1 on a substrate surface can comprise providing an electrolyte solution comprising cations of M1 from which M1 is deposited and a soluble, surface-smoothing additive comprising cations of a second metal (M2) and applying an electrical potential thereby reducing the cations of M1 and forming M1 on the substrate surface. The cations of M2 have an effective electrochemical reduction potential in the solution lower than that of the cations of M1. In preferred embodiments, the methods further comprise accumulating cations of M2 at protrusions on the substrate surface, thereby forming an electrostatically shielded region near each protrusion. The electrostatically shielded region can temporarily repel cations of M1, thus reducing the local effective current density and slowing deposition at the protrusion while enhancing deposition in regions away from the protrusions. In this way, the growth and/or amplification of the protrusions are suppressed and the surface heals to yield a relatively smoother surface.

In one embodiment, the method is applied to electrodeposition of lithium on a substrate surface. Lithium is an effective example because lithium cations have the lowest standard ERP among metals (at a concentration of 1 mol/L, a temperature of 298.15 K (25° C.), and a partial pressure of 101.325 kPa (absolute) (1 atm, 1.01325 bar) for each gaseous reagent). M2 cations, which have standard EPR values that are slightly greater than lithium cations can have activity-dependent effective ERP values that are lower than those of the lithium cations.

According to such embodiments, the method comprises providing an electrolyte solution comprising lithium cations and a soluble, surface-smoothing additive comprising cations of a second metal (M2) selected from the group consisting of cesium, rubidium, potassium, strontium, barium, calcium, and combinations thereof. The cations of M2 have a concentration and activity coefficient in solution such that the effective electrochemical reduction potential of the cations of M2 is lower than that of the lithium cations. The method further comprises applying an electrical potential, thereby reducing the lithium cations and forming lithium on the substrate surface. The method further comprises accumulating cations of M2 at protrusions on the substrate surface, thereby forming an electrostatically shielded region near each protrusion and temporarily repelling the lithium cations from the electrostatically shielded regions. In some instances, the electrostatically shielded region has a higher impedance to retard the further deposition of lithium.

In particular embodiments, the concentration of M2 cations is less than, or equal to 30% of that of the lithium cations. In others, the M2 cation concentration is less than, or equal to, 5% of that of the lithium cations. Preferably, the surface-smoothing additive comprises an anion comprising PF₆⁻ anion. The substrate can be a battery anode that comprises lithium or that comprises carbon.

It has been found that besides lithium dendrite growth as a barrier to producing useful rechargeable lithium battery systems having lithium anodes, another barrier is low Coulombic efficiency of lithium deposition due to a side reaction between the lithium metal and electrolyte solvent or salt during the electrochemical processes. The low Coulombic efficiency of lithium deposition leads to continuous consumption of the lithium metal electrode and reduces the life time of lithium metal batteries. To improve the smoothness as well as Coulombic efficiency of lithium deposition, certain embodiments of the presently disclosed battery systems include electrolyte formulations comprising specific organic solvents and additives chosen in attempt to address the problems noted.

In certain of the disclosed embodiments, the lithium dendrite formation during charging and long-term cycling is addressed using the above-disclosed new additives. These additives work well in an electrolyte comprising a propylene carbonate (PC) solvent. However, the Coulombic efficiency of lithium deposition in PC based electrolyte is relatively low, and thus, is preferably improved through electrolyte chemistry.

With the concerns set forth above in mind, in certain embodiments, differing combinations of organic solvents and additives were studied and resulted in surprisingly superior solid electrolyte interphase (SEI) layers as well as provided surprisingly high Coulombic efficiency of lithium metal deposition. As such, these embodiments provide particularly useful rechargeable lithium metal battery systems with significantly improved safety, lower costs and long-term cycle life.

In certain embodiments the organic solvent in the electrolyte comprises a mixture of ethylene carbonate (EC) and propylene carbonate (PC) at, preferably from 5:5 to 9:1 weight percent, PC, dimethyl carbonate (DMC), ethyl methyl carbonate (EMC), diethyl carbonate (DEC), vinylene carbonate (VC), fluorethylene carbonate (FEC), 4-vinyl-1,3-dioxlan-2-one (VEC), 1,3-dioxlane (DOL), 4-methylene-1,3-dioxlan-2-one (4-methyleneethylene carbonate, EMC), 4,5-dimethylene-1,3-dioxlan-2-one, allyl ether, triallyl amine, triallyl cyanurate, triallyl isocyanurate, or mixtures thereof. In such electrolyte embodiments M1 comprises lithium salt and the surface-smoothing additives compriseCsPF₆, RbPF₆, CsAsF₆, RbCsF₆, or mixtures thereof. Some embodiments of the electrolytes further include an SEI formation additive comprising VC, FEC, VEC, MEC, allyl ether, triallyl amine, tribally cyanurate, tribally isocyanurate, LiAsF₆, LiBOB, LiDFOB, or mixtures thereof.

The purpose of the foregoing summary is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions, the various embodiments, including the preferred embodiments, have been shown and described. Included herein is a description of the best mode contemplated for carrying out the invention. As will be realized, the invention is capable of modification in various respects without departing from the invention. Accordingly, the drawings and description of the preferred embodiments set forth hereafter are to be regarded as illustrative in nature, and not as restrictive.

### DESCRIPTION OF DRAWINGS

Embodiments of the invention are described below with reference to the following accompanying drawings.

FIGS. 1A-1F are illustrations depicting an embodiment of electrodeposition using an electrolyte having a surface-smoothing additive.

FIGS. 2A-2C include SEM micrographs of Li films deposited in an electrolyte with or without a surface-smoothing additive according to embodiments of the present invention; (a) No additive; (b) 0.05 M RbPF₆; (c) 0.05 M CsPF₆.

FIGS. 3A-3B include SEM micrographs of pre-formed dendritic Li film deposited in a control electrolyte for 1 hour and the same film after another 14 hours' Li deposition in the electrolyte with additive (0.05M CsPF6), respectively.

FIGS. 4A-4F include SEM micrographs of Li electrodes after repeated deposition/stripping cycles in the control electrolytes (a, b, and c) and with Cs+-salt additive (d, e and f).

FIGS. 5A-5B include SEM micrographs of Li electrodes after 100 cycles in coin cells of Li|Li₄Tl₅O₁₂ containing electrolytes without (a) and with (b) 0.05 M Cs⁺ additive.

FIGS. 6A-6F include optical and SEM micrographs of hard carbon electrodes after charging to 300% of the regular capacity in the control electrolyte (a, c, e) and in an electrolyte with 0.05 M CsPF₆ additive added in the control electrolyte (b, d, f).

FIG. 7 is a graph of the average Coulombic efficiency of lithium anodes in LilCu cells containing 1 M LiPF₆ and EC-PC mixed solvent electrolytes, with and without the CsPF₆ additive.

FIG. 8 is a graph showing long-term cycling performance of Li|Li₄Ti₅O₁₂ cells containing 1 M LiPF₆/PC electrolytes with and without CsPF₆ additive, cycled at 1 C rate at room temperature.

FIGS. 9A-9D are surface SEM images of lithium deposition morphologies in embodiments of the disclosed electrolytes including 1.0 M LiPF6-based electrolytes containing PC (A), EC (B), DMC (C), and EMC (D).

FIGS. 10A-10D are energy-dispersive X-ray spectroscopy (EDX) dot mappings of copper (represented by green color) for the lithium films deposited on copper substrate using embodiments of the disclosed electrolytes containing PC (A), EC (B), DMC (C), and EMC (D). All electrolytes contain 1 M LiPF₆ salt.

FIGS. 11A-11D are X-ray photoelectron spectroscopy (XPS) spectra of (A) C1s, (B) O1s, (C) Li1s, and (D) F1s of Li lithium deposition surfaces in embodiments of the disclosed electrolytes including EC, PC, EMC and DMC solvents.

FIGS. 12A-12C are SEM images of surface morphology for lithium films deposited in embodiments of the disclosed electrolytes including VC-(A), FEC-(B) and VEC-(C) based and 1.0 M LiPF₆.

FIGS. 13A-13D are XPS spectra of (A) Cis, (B) O1s, (C) Li1s, and (D) F1s of the surface of Li lithium films deposited in embodiments of the disclosed electrolytes comprising EC, VC, FEC and VEC solvents.

FIGS. 14A-14I are SEM images of lithium films deposited in embodiments of the disclosed electrolytes comprising LiBOB (a), LiPF₆ (b), LiAsF₆ (c), LiTFSI (d), LiI (e), LiDFOB (f), LiBF4 (g), LiCF₃SO₃ (h), and LiClO₄ (i) in PC solvent.

FIGS. 15A-15D are XPS spectra of ((A) Cis, (B) O1s, (C) Li1s, and (D) F1s of the Li lithium films deposited in in embodiments of the disclosed electrolytes including different Li lithium salts.

### DETAILED DESCRIPTION

The following description includes the preferred best mode of one embodiment of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

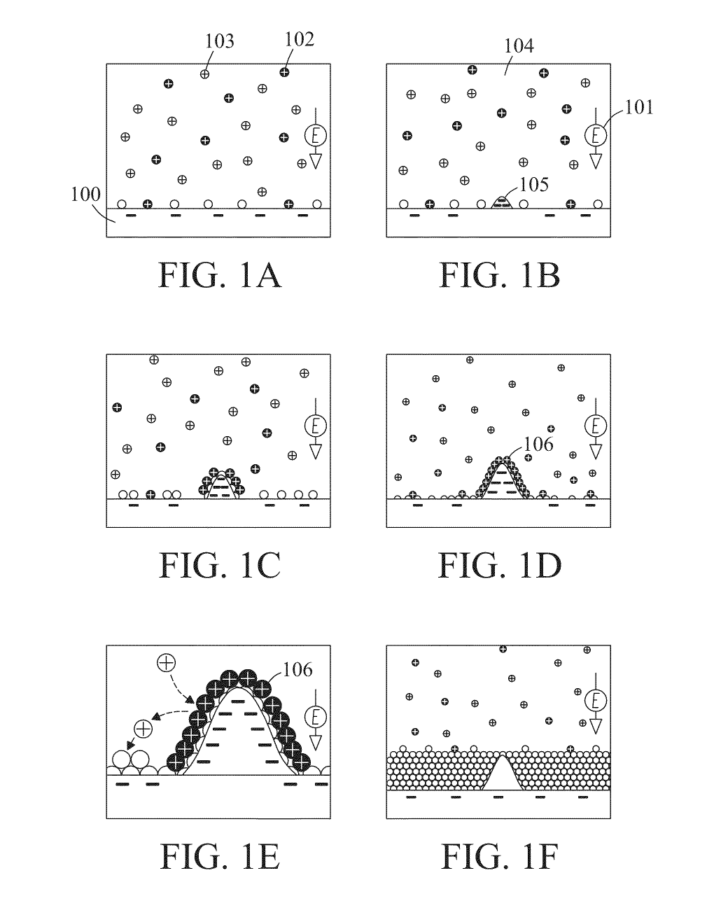

FIGS. 1-6 show a variety of embodiments and aspects of the present invention. Referring first to FIG. 1, a series of illustrations depict an embodiment of electrodeposition using an electrolyte 104 having a surface-smoothing additive. The additive comprises cations of M2 102, which have an effective ERP lower than that of the cations of M1 103. FIG. 1 illustrates how an electrostatically shielded region 106 can develop resulting in the self-healing of the unavoidable occurrence of surface protrusions 105 that would normally form. During the initial stage of deposition, both the cations of M1 and the cations of M2 are adsorbed on the substrate surface 100 (FIG. 1A) under an applied voltage (Eₐ) 101 slightly less than the reduction potential of the reactant (Eᵣ) but larger than the additive reduction potential (E_{M2/M2}+), that is, E_{M2M2}+. Reactants will be deposited to form M1 on the substrate and will unavoidably form some protuberance tips due to various fluctuations in the system (FIG. 1B). A sharp edge or protrusion on the electrode exhibits a stronger electrical field, which will attract more positively charged cations (including both M1 and M2). Therefore, more cations of M1 will be preferentially deposited around the tips rather than on other smooth regions. In conventional electrodeposition, amplification of this behavior will form the surface roughness and/or dendrites. However, according to embodiments of the present invention, the adsorbed additive cations (M2⁺) have an effective ERP lower than Ea (FIG. 1C) and will not be deposited (i.e., electrochemically or chemically consumed, reacted, and/or permanently bound) on the tip. Instead, they will be temporarily electrostatically attracted to and accumulated in the vicinity of the tip to form an electrostatic shield (FIG. 1D). This positively charged shield will repel incoming reactants (e.g., like-charged species) at the protruded region and redirect them to be deposited in non-protrusion regions. The net effect is that reactants will be preferentially deposited in the smoother regions of the substrate (FIG. 1E) resulting in a smoother overall deposition surface (FIG. 1F). This process is persistently occurring and/or repeating during electrodeposition. The self-healing mechanism described herein resulting from embodiments of the present invention appears to disrupt the conventional roughness and/or dendrite amplification mechanism and leads to the deposition of a smooth film of M1 on the substrate.

The additive cation (M2⁺) exhibits an effective ERP, E_{Red} , less than that of the cations (M1⁺) of the cations of M1. In some instances, the standard ERP of the M2 cation will be less than that of the cations of M1. Surface-smoothing additives comprising such M2 species can be utilized with appropriate reactants with few limitations on concentration and activity coefficient. However, in some instances, the M2 cation will have a standard ERP that is greater than that of the cations of M1. The concentration and activity coefficient of the M2 cations can be controlled such that the effective ERP of the M2 cations is lower than that of the reactant cations. For example, if the reactant is a lithium cation, which has the lowest standard ERP among metals, then the concentration and activity coefficient of M2 cations can be controlled such that the effective ERP is lower than that of the lithium cations.

According to the Nernst equation:

$${E}_{Red} = {E}_{Red}^{φ} - \frac{RT}{zF} ln \frac{{α}_{Red}}{{α}_{Ox}} \qquad ( 1 )$$

wherein R is the universal gas constant (=8.314 472 J K⁻mol⁻), T is the absolute temperature (assume T=298.15K in this work), a is the activity for the relevant species (α_{Red} is for the reductant and α_{Oxo}is for the oxidant). αₛ=γₓcₓ, where γₓ and cₓ are the activity coefficient and the concentration of species x. F is the Faraday constant (9.648 533 99×10⁴ C mol⁻¹), z is the number of moles of electrons transferred. Although lithium cation has the lowest standard reduction potential, E_{Red} (Li⁺), among all the metals when measured at a standard conditions (1 mol/L), a cation (M⁺) may have an effective reduction potential lower than those of lithium ion (Li⁺) if M⁺ has an activity αₓ much lower than that of Li⁺. In the case of low concentration when the activity coefficient is unity, a can be simplified as concentration cₓ , then Eq. (1) can be simplified as:

$${E}_{Red} = {E}_{Red}^{φ} - \frac{0.05916 V}{z} {log}_{10} \frac{1}{{c}_{Ox}} \qquad ( 2 )$$

Table 1 shows several the reduction potentials for several cations (vs. standard hydrogen electrode (SHE)) at various concentrations assuming that their activity coefficients, γₓ, equal one. When the concentration of Cs⁺, Rb⁺, and K⁺ is 0.01 M in an electrolyte, their effective ERPs are −3.144 V, −3.098 V and −3.049 V, respectively, which are less than those of Li⁺ at 1 M concentration (−3.040 V). As a result, in a mixed electrolyte where the additive (Cs⁺, Rb⁺, and K⁺) concentration is much less than Li⁺ concentration, these additives will not be deposited at the lithium deposition potential. In addition to a low concentration cₓ, a very low activity coefficient γₓ (which is strongly affected by the solvation and mobility of the cations in the given solvent and lithium salt) may also reduce the activity of cations and lead to an effective reduction potential lower than that of the lithium cation (Li⁺) as discussed below.

TABLE 1
The effective reduction potential of selected cations vs. SHE

| | Li⁺ | Cs⁺ | Rb⁺ | K⁺ |
|---|---|---|---|---|
| Stand reduction | −3.040 V | −3.026 V | −2.980 V | −2.931 V |
| potential (1M) | | | | |
| Effective reduction | — | −3.103 V | −3.06 V | −3.01 V |
| potential at 0.05M* | | | | |
| Effective reduction | — | −3.144 V | −3.098 V | −3.049 V |
| potential at 0.01M* | | | | |

*Assume the activity coefficient γₓ of species x equals 1.

### Surface Smoothing Exhibited in Electrodeposition of Lithium

Embodiments of the present invention are illustrated well in the electrodeposition of lithium, since lithium ions have the lowest standard reduction potential among metals. However, the present invention is not limited to lithium but is defined by the claims.

The effect of several M2 cations has been examined for use in surface-smoothing additives in the electrodeposition of lithium. The cations all have standard reduction potential values, E_{Red}^{φ}, that are close to that of Li⁺ ions. The electrolyte comprised 1 M LiPF₆ in propylene carbonate. Electrolyte solutions with surface-smoothing additives comprising 0.05 M RbPF₆, or 0.5 M CsPF₆ were compared to a control electrolyte with no additives. CsPF₆, RbPF₆, and Sr(PF₆)₂ were synthesized by mixing stoichiometric amount of AgPF₆ and the iodide salts of Cs, Rb, or Sr in a PC solution inside a glove box filled with purified argon where the oxygen and moisture content was less than 1 ppm. The formed Agl was filtered out from the solution using 0.45 μm syringe filters. The electrolyte preparation and lithium deposition were conducted inside the glove box as well. Lithium films were deposited on copper (Cu) foil substrates (10 mm×10 mm) in different electrolyte solutions at the desired current densities using a SOLARTRON® electrochemical Interface. After deposition, the electrode was washed with DMC to remove the residual electrolyte solvent and salt before the analyses.

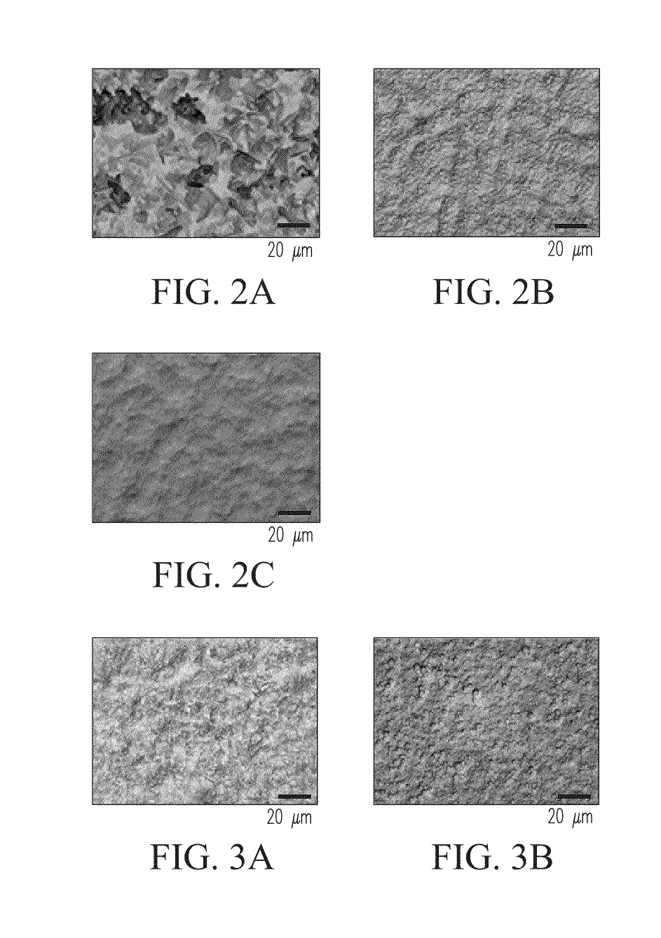

Referring to the scanning electron microscope (SEM) micrograph in FIG. 2A, when using the control electrolyte, the electrodeposited film exhibited conventional roughness and dendrite growth. The lithium film deposited in the electrolyte with 0.05 M Rb⁺0 as the M2 cation exhibits a very fine surface morphology without dendrite formation as shown in FIG. 2B. Similarly, for the lithium films deposited with 0.05 M Cs⁺ additive, a dramatic change of the lithium morphology with no dendrite formation (see FIG. 2C) was obtained compared with the control experiment. Generally, the concentration of the surface-smoothing additive is preferably high enough that protrusions can be effectively electrostatically shielded considering the effective ERP, the number of available M2 cations, and the mobility of the M2 cations. For example, in one embodiment, wherein the M2 cation comprises Rb⁺, the reactant comprises Li⁺ and M1 comprises lithium metal, the concentration of Rb⁺ is greater than 0.01M.

Referring to FIG. 3A, a dendritic lithium film was intentionally deposited on a copper substrate in a control electrolyte for 1 hour. The substrate and film was then transferred into an electrolyte comprising a surface-smoothing additive, 0.05 M CsPF₆ in 1 M LiPF₆/PC, to continue deposition for another 14 hours. Unlike the dendritic and mossy film deposited in the control electrolyte, the micrograph in FIG. 3B shows that a smooth lithium film was obtained after additional electrodeposition using embodiments of the present invention. The roughness, pits, and valleys shown in FIG. 3A have been filled by dense lithium deposits. The original needle-like dendritic whiskers have been converted to much smaller spherical particles which will also be buried if more lithium is deposited.

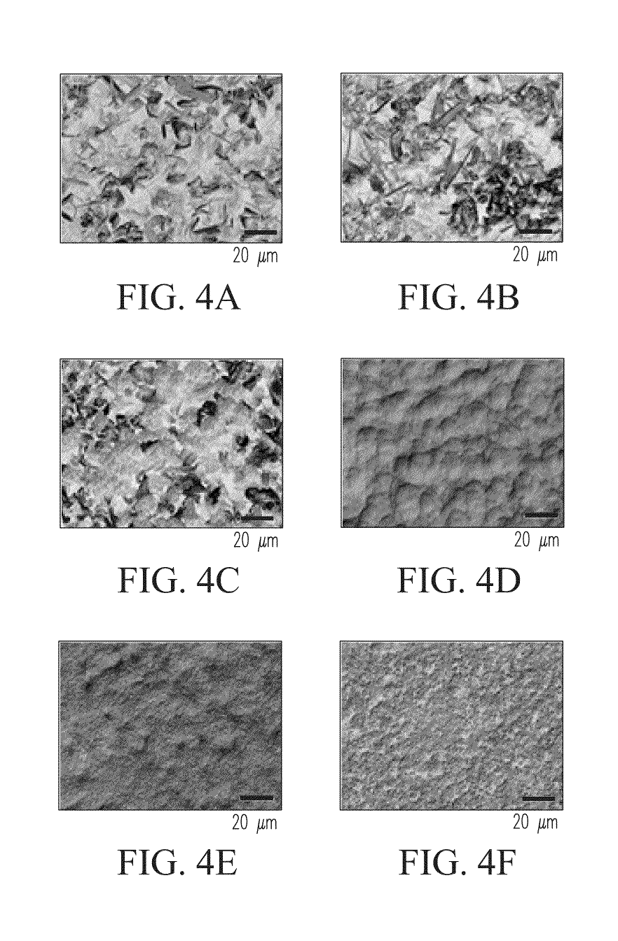

FIG. 4 includes SEM micrographs comparing the morphologies of the lithium electrodes after repeated deposition/stripping cycles (2^{nd}, 3^{rd}, and 10^{th} cycle) in cells using the control electrolyte (see FIGS. 4A, 4B, and 4C) and using electrolyte with a surface-smoothing additive comprising 0.05M Cs⁺(see FIGS. 4D, 4E, and 4F). The large lithium dendrites and dark lithium particles are clearly observed on the lithium films deposited in the control electrolyte. In contrast, the morphologies of the lithium films deposited in the Cs⁺-containing electrolyte still retain their dendrite free morphologies after repeated cycles. In all the films deposited with the additives, lithium films exhibit small spherical particles and smoother surfaces. This is in strong contrast with the needle-like dendrites grown in the control electrolyte.

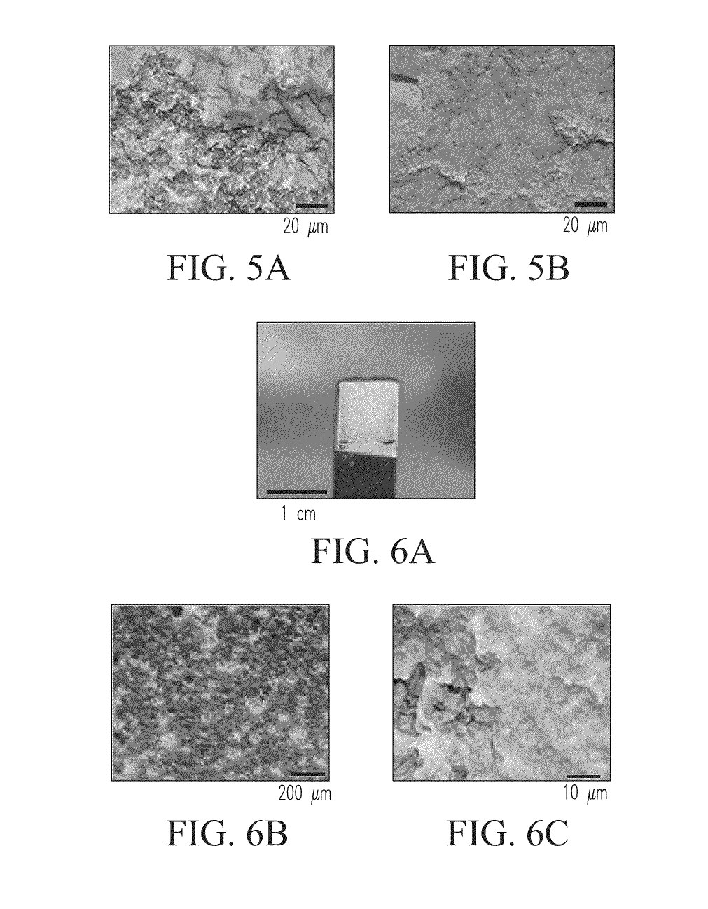

Electrolytes and methods described herein were also applied in rechargeable lithium metal batteries. Coin cells with Li|Li₄Ti₅O₁₂ electrodes were assembled using the control electrolyte. Similar cells were also assembled with electrolytes containing a surface-smoothing additive comprising 0.05 M Cs⁺. FIG. 5 contains SEM micrographs showing the morphologies of the lithium metal anodes after 100 charge/discharge cycles. Referring to FIG. 5A, the lithium electrode in the cell with no additive exhibits clear surface roughness and formation of dendrites. However, as shown in FIG. 5B, no dendritic lithium was observed on the lithium electrode in the cell with the surface-smoothing additive, even after 100 cycles.

Surface-smoothing additives comprising higher valence cations can also be used. Examples include, but are not limited to, Sr²⁺, which have E_{Red}^{φ} values of −2.958 V (assuming γ=1) versus a standard hydrogen potential. The lower activity of these cations can result in an effective ERP lower than that of Li⁺ ions. The larger size and higher charge should be accounted for in the non-aqueous electrolyte. Lithium films were deposited using the control electrolyte along with electrolytes comprising 0.05 M Sr(PF₆)₂. Deposition from the electrolyte comprising 0.05 M Sr²⁺ results in a lithium film that is smooth, free of dendrites, and void of Sr in/on the anode. This again indicates that the activity coefficient for Sr²⁺ in these solutions is less than unity.

Using this approach, M2 cations of the surface-smoothing additive are not reduced and deposited on the substrate. The M2 cations are not consumed because these cations exhibit an effective reduction potential lower than that of the reactant. In contrast, traditional electrodeposition can utilize additives having a reduction potential higher than that of the cations of M1; therefore, they will be reduced during the deposition process and “sacrificed or consumed,” for example, as part of an SEI film or as an alloy to suppress dendrite growth. As a result, the additive concentration in the electrolyte will decrease with increasing charge/discharge cycles and the effect of the additives will quickly degrade. In contrast, the M2 cations described herein will form a temporary electrostatic shield or “cloud” around the dendritic tips that retards further deposition of M1 in this region. This “cloud” will form whenever a protrusion is initiated, but it will dissipate once applied voltage is removed or the protrusion is eliminated. Accordingly, in some embodiments, the applied electrical potential is of a value that is less than, or equal to, the ERP of the cations of M1 and greater than the effective ERP of the cations of M2.

Lithium films having an SEI layer on the surface and deposited using electrolytes comprising 0.05 M Cs⁺, Rb⁺, or Sr²⁺ additives were analyzed by x-ray photoelectron spectroscopy (XPS), Energy-dispersive X-ray spectroscopy (EDX) dot mapping, and Inductively coupled plasma atomic emission spectroscopy (ICP/AES) methods. XPS and EDX results did not show Cs, Rb, and Sr elements in the SEI films within the detectable limits of the analysis instruments. In addition, ICP-AES analysis did not identify Cs, Rb, and Sr elements in the bulk of deposited lithium film (including the SEI layer on the surface) within detectable limits.

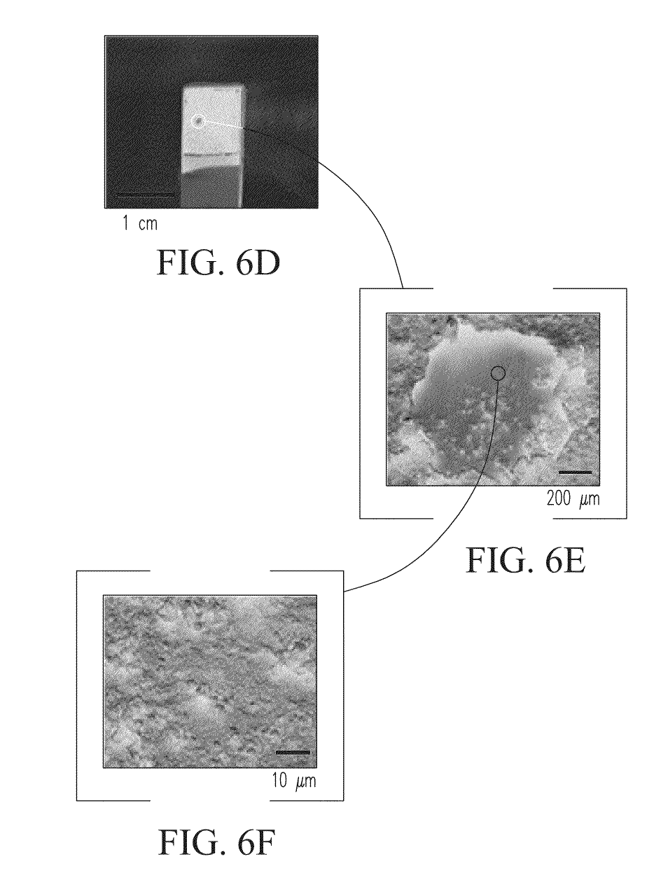

Dendrite formation is not only a critical issue in rechargeable lithium metal batteries, but also an important issue in high power lithium ion batteries because lithium metal dendrites can grow at the anode surface when the lithium ions cannot move quickly enough to intercalate into the anode, which can comprise graphite or hard carbon, during rapid charging. In this case, the lithium dendrites can lead to short circuits and thermal runaway of the battery. Accordingly, a carbonaceous anode is described herein to demonstrate suppression of lithium dendrite growth in a lithium ion battery. FIG. 6 compares the optical (6A and 6D) and SEM images (6B, 6C, 6E, and 6F) of lithium particles formed on the hard carbon anode after it was charged to 300% of its theoretical capacity in a control electrolyte (without additives) and in an electrolyte having a surface-smoothing additive comprising 0.05 M CsPF₆. A significant amount of lithium metal was deposited on the surface of carbon electrode (see grey spots in FIG. 6A) for the sample overcharged in the control electrolyte. FIGS. 6B and 6C show clear dendritic growth on the electrode surface. In contrast, no lithium metal deposition was observed on the surface of carbon electrode (see FIG. 6D) for the sample overcharged in the electrolyte with 0.05M Cs⁺ additive (the white line on the bottom of the carbon sample is due to an optical reflection). After removing a small piece of carbon from the sample (see the circled area in FIG. 6D), it was found that excess lithium was preferentially grown on the bottom of the carbon electrode as shown in FIGS. 6E and 6F.

Dendrite Suppression Electrolytes with High Coulombic Efficiency for Metal Deposition

Certain embodiments disclosed herein combine the above-disclosed electrolytes for suppression of dendrite formation additives and also improve the long-term cycle life of lithium-ion battery systems through combination with particular organic solvents and additives. The disclosed organic solvents and their mixtures form high-quality SEI layers on the lithium anode surface and prevent further reactions between lithium and electrolyte components. Such electrolyte embodiments further comprise new additives to suppress dendrite growth during charge/discharge processes. The combination of these components significantly improve both the Coulombic efficiency and smoothness of lithium deposition.

In certain embodiments the electrolyte comprises organic solvents selected from a mixture of EC and PC at, preferably EC/PC in a range from 5:5 to 9:1 weight percent, PC, EMC, DMC, DEC, VC, FEC, VEC, MEC, 1,2-dimethoxyethane (DME), DOL; a lithium salt selected from LiPF₆, LiAsF₆, LiBF₄, LiTFSI, LiClO₄, LiBOB, LiDFOB, and mixtures thereof; a surface-smoothing additive selected from CsPF₆, RbPF₆, CsAsF₆, RbAsF₆, and mixtures thereof; and an SEI formation additive selected from VC, FEC, VEC, MEC, allyl ether, triallyl amine, tribally cyanurate, tribally isocyanurate, LiAsF₆, LiBOB, LiDFOB, and mixtures thereof. In certain embodiments the concentrations of the surface-smoothing additives range from about 0-30% by mole of the M1 salt concentration, with a particularly useful concentration being about 1-10% by mole of the main lithium salt concentration. In certain embodiments the concentration of the SEI formation additives are about 0.1-10% by weight in the electrolyte, with a particularly useful concentration being about 0.5-3% by weight in the electrolyte. In certain embodiments of the electrolyte VC, FEC, VEC, and/or MEC can be present as a solvent when its content is equal to or above 10% by weight in the electrolyte, or as an SEI formation additive when ifs content is less than 10% by weight in the electrolyte. Note that when LiAsF₆, LiBOB, LiDFOB are present in the electrolyte in concentrations equal to or above 8% by weight they act as an M1 salt (a major salt), but when their concentrations in the electrolyte are below 8% by weight they act as an SEI formation additive.

For further comparison data and evaluation of embodiments of the disclosed electrolytes, further testing of electrolyte solvents comprising carbonate solvents were compared for Coulombic efficiency effects. The electrolyte solvents were obtained from Novolyte Technologies in battery grade unless specified otherwise. The solvents tested in this analyses include ethylene carbonate (EC), propylene carbonate (PC), dimethyl carbonate (DMC), ethyl methyl carbonate (EMC), vinylene carbonate (VC), fluorethylene carbonate (FEC, 99%, Solvay Chemicals) and 4-vinyl-1,3-dioxlan-2-one (VEC, 99%, Sigma-Aldrich). VEC was dehydrated with 3A molecular sieves for more than one week before use. In addition, various Li salts were also evaluated, including LiPF₆, LiBF₄, LiAsF₆, LiClO₄, LiTFSI, LiCF₃SO₃, Li-BOB, LiDFOB, and Li|LiPF₆, LiBF₄ and LiTFSI (all in battery grade) were obtained from Novolyte Technologies. The LiBOB (battery grade) sample was obtained from Chemetall. LiClO₄ (99.99%) and LiCF₃SO₃ (99.995%) were from Sigma-Aldrich. LiAsF₆ (99%) and Lil (99.95%) were obtained from Alfa Aesar and dried under vacuum (about 0.1 Pa due to the limitation of the vacuum pump) overnight before being stored in an MBraun glove box filled with purified argon (99.999%). The moisture content and oxygen content inside the glove box were less than 1 ppm and 10 ppm, respectively. All other salts were used as received.

Electrolytes tested had a salt concentration of 1.0 M and were prepared in an argon-filled glove box. The morphologies of Li electrode surfaces prepared in different electrolytes were analyzed using a polished and well-cleaned Cu foil as the substrate (10 mm×10 mm). Li metal was electrodeposited onto the Cu substrate from the test electrolyte to form the Li electrode. Each electrodeposition process was conducted for 15 h at 0.1 mA cm⁻² current density using the CHl660C workstation (CH Instruments). After deposition, the electrodes were washed thoroughly with DMC to remove the residual electrolyte solvent and salt, and finally evacuated to remove the residual DMC. The average CEs of Li electrodes deposited in electrolytes with different carbonate solvents and/or different Li salts were measured as discussed above.

Surface morphologies of deposited Li electrodes were measured by scanning electron microscopy (SEM) using a JEOL 5900 scanning electron microscope. The surface element composition was examined by energy dispersive X-ray fluorescence spectrometer (EDX) (JEOL 2010). Samples were mounted onto the SEM sample holders in the argon-filled glove box, transferred in an airtight container and loaded into the SEM/EDX chamber in a glove bag purged with pure nitrogen to avoid air contamination. The components of the surface layers on the deposited Li electrodes were analyzed by X-ray photoelectron spectroscopy (XPS) with a Physical Electronics Quantera scanning X-ray microprobe. The C1s peak at 284.8 eV was used for referencing.

Certain embodiments of the disclosed electrolytes comprise PC, EC-PC-DMC, or EC-PC-EMC, or EC-PC-DMC-EMC as a solvent, LiPF6 as a main lithium salt (M1 salt), CsPF₆ as a surface-smoothing additive, and VC, FEC, MEC, LiAsF6, or mixtures thereof, as an SEI formation additive. Particular embodiments of the electrolyte may comprise about 1.0M LiPF6 in EC-PC-EMC (5:2:3 by weight) with about 0.05M CsPF₆ and about 2 wt % VC or FEC, about 1.0M LiPF6 in EC-EMC (3:7 by volume) with about 0.05M CsPF₆ and 2 wt % LiAsF₆ and 2 wt % VC or FEC.

The average lithium Coulombic efficiency of different aprotic solvents, salts and additives were tested in LilCu cells. The charge/discharge protocol followed the method proposed by Aurbach et al. (Aurbach, D.; Youngman, O.; Gofer, Y.; Meitav, A. Electrochim. Acta 1990, 35, 625-638, incorporated herein by reference) with slight modification (added one more Li deposition and full stripping cycle before using the testing procedure described by as Aurbach). CR2032 coin cells (known to those skilled in the art) were crimped with a polished Cu foil, a glass fiber separator (500pm thick, GF-B, Whatman), a Li foil, and 200 pL testing electrolyte. The cells were charged (Li deposition) and discharged (Li stripping) using an Arbin battery test system (BT2000) at 0.2 mA cm⁻². The Li deposition/stripping protocol was used as below. First, a charge of 5 C cm⁻² was deposited on and completely stripped off the Cu substrate. Second, another charge of 5 C cm⁻² was deposited on Cu foil but a charge of 1.25 C cm⁻² was stripped and deposited for 9 cycles. Finally, the Li was completely stripped at a cutoff voltage of 1 V. The average Coulombic efficiency was calculated according to the following equation:

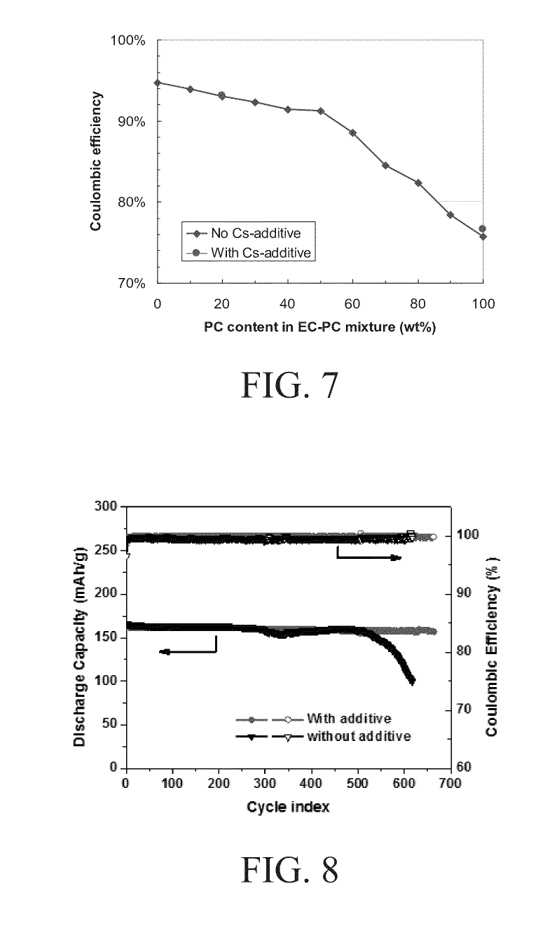

Coulombic efficiency=(n×Qᵣ+Q_{s,final})/(Q_{d,2nd}+n×Qᵣ)×100%

where n is the cycle number at Qᵣ striping and deposition, Qᵣ is the charge during the cycling and is 1.25 C cm⁻² here, Q_{s,final} is the charge during the final stripping, and Q_{d,2nd} is the charge during 2^{nd} deposition and is 5 C cm⁻². The average Coulombic efficiency of lithium anodes in 1 M LiPF6 electrolytes with an EC-PC mixed solvent is shown in FIG. 7. X-axis in FIG. 7 represents the weight percentage of PC in EC-PC mixture. Table 2 shows the summary of average lithium Coulombic efficiency obtained in 1 M LiPF₆-based electrolytes. The electrolytes including PC as the electrolyte solvent provides a relatively low Coulombic efficiency of about 76%. The currently disclosed electrolyte embodiments comprising a mixture of EC and PC provide relatively high lithium Coulombic efficiencies. When the EC content is above 50% by wt. of EC in the EC-PC mixture, the lithium Coulombic efficiency is above 91%. The Coulombic efficiency of Li deposition in pure LiPF6/EC electrolyte is close to 95%.

When adding 0.05 M CsPF₆ in the electrolytes, the Coulombic efficiency of lithium deposition was maintained or slightly increased, and more importantly, the deposited lithium films became mirror-like by eye-view and no dendrites were formed, even in the electrolyte containing the EC-PC mixture (8:2 by wt.). Accordingly, Coulombic efficiency can be increased using the disclosed solvents while additives can also be included to inhibit or prevent dendrite growth without the solvent hindering the additive or vice versa.

Embodiments of the disclosed electrolytes comprising FEC, VEC or VC in 1 M LiPF₆ provide surprisingly superior lithium Coulombic efficiency, even as compared to EC, of above 97%. With reference to Table 2, the electrolyte solutions also comprised LiPF6 at 1M without or with CsPF₆, as listed. In certain embodiments, these solvents are added as co-solvents or additives into the electrolyte solutions to protect lithium metal anodes from chemical reactions with electrolyte solutions and to further increase the Coulombic efficiency of lithium anode. The average CEs of Li electrodes in LilCu coin cells with four different carbonate electrolytes are shown in Table 2. Cyclic carbonate electrolytes (PC and EC) give higher CEs of Li electrodes than linear carbonates (DMC and EMC). The average CE is higher than 75% for PC- or EC-based electrolyte but lower than 25% for DMC- or EMC-based electrolyte. The higher CE obtained in cyclic-carbonate-based electrolyte can be attributed to a strong and flexible SEI layer formed by the reduction and polymerization of cyclic carbonates on the Li surface. As a result, the Li electrode shows a higher efficiency in cyclic carbonates than in linear carbonates. Notably, the EC-based electrolyte leads to a high CE (-95%) of a Li electrode among the several carbonate-based electrolytes studied in this work. An EC-based electrolyte can improve the morphology of the Li film during the repeated charge/discharge cycles, and it is more suitable for long-term cycling. Comparing with EC, although PC makes the Li deposition with more coverage on the Cu substrate than that from EC-based electrolyte (see FIGS. 10A-D), Li CE in EC-based electrolyte (94.8%) is much higher than in PC-based electrolyte (76.5%). Cyclic carbonates—VC, FEC and VEC, embodiments of the presently disclosed electrolytes were found to be easily reduced and polymerized on the anode surface to form good SEI layers that significantly enhance performances of graphite or Li metal anodes.

TABLE 2
Summary of average lithium Coulombic efficiency
in 1M LiPF₆-based electrolytes

| | |
|---|---|
| Carbonate | Average lithium Coulombic efficiency |

| solvent | Without CsPF₆ | With 0.05M CsPF₆ |
|---|---|---|
| PC | 75.7% | 76.6% |
| EC | 94.8% | |
| EC-PC (8:2 wt) | 93.1% | 93.1% |
| DMC | 23.6% | |
| EMC | 7.3% | |
| VC | 97.1% | |
| VEC | 97.6% | |
| FEC | 98.2% | |

Certain of the disclosed electrolyte compositions comprise ether-based solvents and different lithium salts and surface-smoothing additives as set forth in Tables 3 and 4 below. Embodiments of electrolytes comprising 1 M LiTFSI and the solvents DME, diglyme, triglyme, tetraglyme, THF or DOL, are disclosed and were tested as set forth above. With reference to Table 3, certain of the electrolyte solutions also comprised LiTFSI without or with CsTFSI. The average lithium Coulombic efficiency data is listed in Tables 3 and 4, respectively.

TABLE 3
Summary of average lithium Coulombic efficiency
in 1M LiTFSI-based electrolytes

| | Average lithium Coulombic efficiency | | |
|---|---|---|---|
| | No Cs- | 0.01M CsTFSI | 0.05M CsTFSI |
| Solvent | additive | Additive | Additive |
| DME | 61.1% | | |
| Diglyme | 36.8% | | |
| Triglyme | 54.1% | | |
| Tetraglyme | 42.0% | | |
| THF | 78.8% | 80.2% | 79.2% |
| DOL | 94.0% | 93.0% | 93.7% |

TABLE 4
Summary of average lithium Coulombic
efficiency in DOL-based electrolytes

| | Average lithium |
|---|---|
| Lithium salt | Coulombic efficiency |
| LiTFSI | 94.0% |
| LiClCO₄ | 90.6% |
| LiAsF₆ | 99.1% |

In a particular embodiment the electrolyte comprises 1M LiPF6 in PC solvent and 0.05M CsPF₆ surface smoothing additive, 2 wt % VC and 2 wt % LiAsF₆ as SEI formation agent. This electrolyte provides substantially dendrite-free Li film deposition with a Coulombic efficiency of 97.51%. Other examples of the electrolyte compositions and associated Coulombic efficiency are shown in Table 5. All of the Li films deposited using the electrolytes shown in Table 5 are substantially dendrite free.

TABLE 5
Coulombic efficiency of Li films deposited
using various electrolyte.

| | | Average Coulombic | Dendrite- |
|---|---|---|---|
| Sample | Electrolyte solution | efficiency (%) | free |
| #1 | 1M LiPF₆ in PC + | 74.69 | Yes |
| | 0.05M CsPF₆ | | |
| #2 | 1M LiPF₆ in PC + | 80.86 | Yes |
| | 0.05M CsPF₆ + | | |
| | 2 wt % LiAsF₆ | | |
| #3 | 1M LiPF₆ in PC + | 92.58 | Yes |
| | 0.05M CsPF₆ + | | |
| | 2 wt % VC | | |
| #4 | 1M LiPF₆ in PC + | 97.51 | Yes |
| | 0.05M CsPF₆ + | | |
| | 2 wt % VC + | | |
| | 2 wt % LiAsF₆ | | |

The inventors have discovered that the nature of the organic solvent has a surprisingly significant effect on the average Coulombic efficiency of lithium deposition and in turn upon the performance of rechargeable lithium metal batteries using electrolytes comprising the same. The selection of solvents plays a dominate role in determining the Coulombic efficiency of lithium deposition. The selection of the disclosed lithium salts above, also play an important role.

The effect of electrolyte additives on the cycling stability of lithium metal batteries has been investigated. FIG. 8 shows the capacity of Li|Li₄Ti₅O₁₂ cells as a function of cycle number when it is cycled at 1 C rate in LiPF₆/PC electrolyte with and without CsPF₆ additive. The sample using the control electrolyte exhibit a sharp capacity fading after 500 cycles due to the lithium dendrite formation causing the internal short-circuit. However, with the addition of 0.05 M CsPF₆, the cycle life was extended to about 660 cycles without short-circuiting. This long cycle life is based on the excess lithium used as anode. It is anticipated that by replacing the low Coulombic efficiency solvent (PC in FIG. 8) with high Coulombic efficiency solvents as disclosed above, adding appropriate SEI formation additives and optimizing the electrolyte formulations (such as 1M LiPF₆ in PC +0.05M CsPF6+2 wt % VC+2 wt % LiAsF6 shown in Table 5), the cycling performance of these cells can be further improved.

For further comparison data and evaluation of embodiments of the disclosed electrolytes, further testing of electrolyte solvents comprising carbonate solvents were compared for Coulombic efficiency effects. The electrolyte solvents were obtained from Novolyte Technologies in battery grade unless specified otherwise. The solvents tested in this analyses include ethylene carbonate (EC), propylene carbonate (PC), dimethyl carbonate (DMC), ethyl methyl carbonate (EMC), vinylene carbonate (VC), fluorethylene carbonate (FEC, 99%, Solvay Chemicals) and 4-vinyl-1,3-dioxlan-2-one (VEC, 99%, Sigma-Aldrich). VEC was dehydrated with 3A molecular sieves for more than one week before use. In addition, various Li salts were also evaluated, including LiPF₆, LiBF₄, LiAsF₆, LiClO₄, LiTFSI, LiCF₃SO₃, Li-BOB, LiDFOB, and Lil. LiPF₆, LiBF₄ and LiTFSI (all in battery grade) were obtained from Novolyte Technologies. The LiBOB (battery grade) sample was obtained from Chemetall. LiClO4 (99.99%) and LiCF₃SO₃ (99.995%) were from Sigma-Aldrich. LiAsF₆ (99%) and Lil (99.95%) were obtained from Alfa Aesar and dried under vacuum (about 0.1 Pa due to the limitation of the vacuum pump) overnight before being stored in an MBraun glove box filled with purified argon (99.999%). The moisture content and oxygen content inside the glove box were less than 1 ppm and 10 ppm, respectively. All other salts were used as received.

Electrolytes tested had a salt concentration of 1.0 M and were prepared in an argon-filled glove box. The morphologies of Li electrode surfaces prepared in different electrolytes were analyzed using a polished and well-cleaned Cu foil as the substrate (10 mm×10 mm). Li metal was electrodeposited onto the Cu substrate from the test electrolyte to form the Li electrode. Each electrodeposition process was conducted for 15 h at 0.1 mA cm⁻² current density using the CHI660C workstation (CH Instruments). After deposition, the electrodes were washed thoroughly with DMC to remove the residual electrolyte solvent and salt, and finally evacuated to remove the residual DMC. The average CEs of Li electrodes deposited in electrolytes with different carbonate solvents and/or different Li salts were measured as discussed above.

Surface morphologies of deposited Li electrodes were measured by scanning electron microscopy (SEM) using a JEOL 5900 scanning electron microscope. The surface element composition was examined by energy dispersive X-ray fluorescence spectrometer (EDX) (JEOL 2010). Samples were mounted onto the SEM sample holders in the argon-filled glove box, transferred in an airtight container and loaded into the SEM/EDX chamber in a glove bag purged with pure nitrogen to avoid air contamination. The components of the surface layers on the deposited Li electrodes were analyzed by X-ray photoelectron spectroscopy (XPS) with a Physical Electronics Quantera scanning X-ray microprobe. The C1s peak at 284.8 eV was used for referencing.

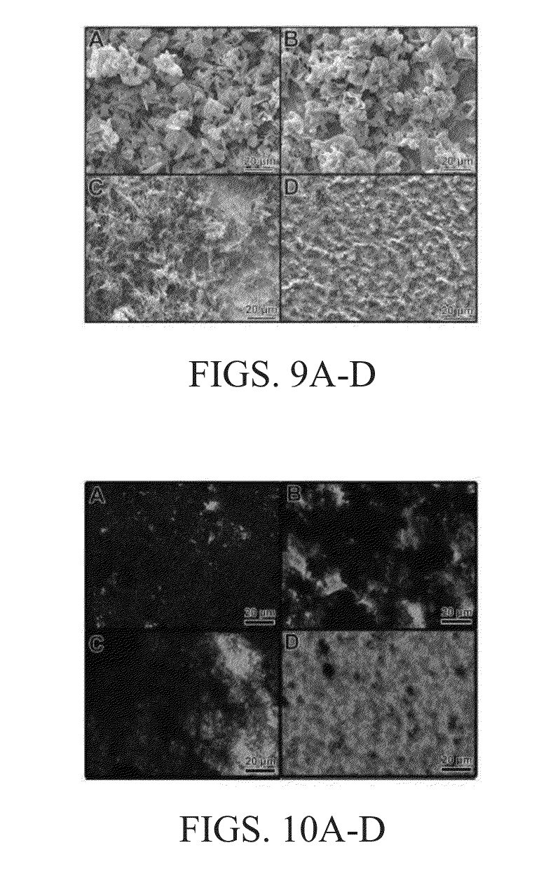

FIGS. 9A-D show SEM images of the surface morphologies of Li electrodes deposited in the electrolytes of 1.0 M LiPF6 in four single-carbonate solvents, PC (A), EC (B), DMC (C) and EMC (D). It is seen that Li clusters or dendrites form in all four carbonate solvent-based electrolytes but the morphologies of the deposited Li films are quite different. The morphologies of Li films deposited from the electrolytes of two cyclic carbonates (EC and PC) are similar but they are very different from those deposited in the electrolytes of linear carbonate solvents (EMC and DMC).

The coverage information of the Li film deposited on the Cu substrate is shown in FIGS. 10A-D, which show the EDX dot mapping of Cu of the four Li films deposited in electrolytes based on PC (A), EC (B), DMC (C) and EMC (D). Since EDX technology can only show elements heavier than beryllium, Li cannot be detected by EDX. However, the compatibility and uniformity of the deposited Li films can still be observed from the EDX profile of the substrate (Cu). Where the Li coverage on Cu substrate is dense and thick, there is less Cu detected by EDX; while where the Li is not deposited well, more Cu can be found. FIG. 10A shows that the Li film deposited in the PC based electrolyte is very compact and homogeneous. It covers nearly all of the Cu substrate so only a small amount of Cu was detected. The EC-based electrolyte (see FIG. 10B) leads to slightly poorer coverage and a less dense Li deposition layer on the Cu substrate than that deposited in PC-based electrolyte. In contrast, a large amount of Cu was observed on the Li films deposited in electrolytes based on DMC (see FIG. 10C) and EMC (see FIG. 10D) based electrolytes. In the case of the EMC-based electrolyte, only a very small portion of the Cu surface is covered by clusters of Li deposition. These results indicate that Li film can be much more easily deposited in cyclic carbonate (PC and EC)-based electrolytes, but it is very difficult to deposit Li film in linear carbonate (DMC and EMC)-based electrolytes.

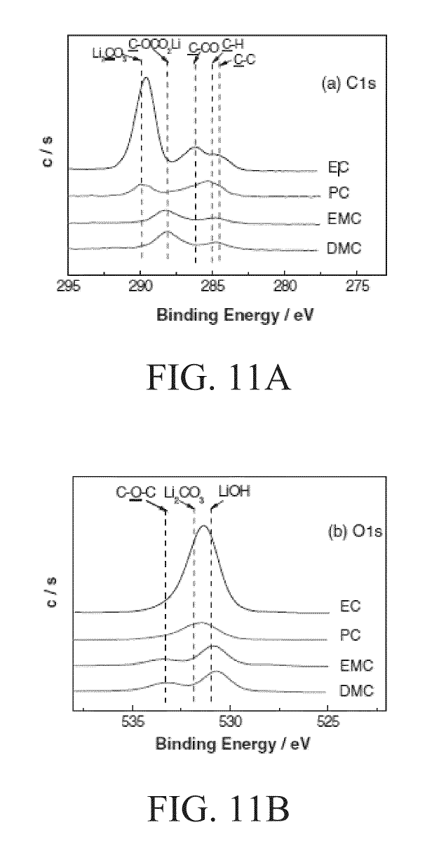

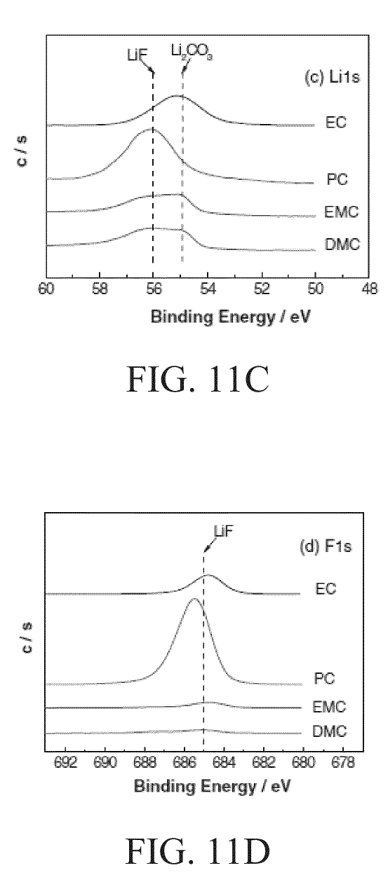

The results of SEM and EDX shown in FIGS. 9A-D and 10A-D indicate that the morphology of a Li electrode deposited from cyclic carbonate electrolytes shows much better uniformity and compactness than those deposited from linear carbonate electrolytes. It has been reported that during the deposition process Li metal readily forms a mossy or dendritic morphology because of the deposition dynamics. The morphology of the deposited Li film depends strongly on the solvent, salt and additive used in the electrolytes. A high quality SEI film formed on the Li surface greatly improves the morphology of deposited Li films. The compositions of the SEI films formed on the surfaces of deposited Li films were analyzed by XPS technique. FIGS. 11A-D show the XPS spectra of the Li films deposited in the aforementioned four carbonate-based electrolytes. FIG. 11A is for the C1s spectra. The peak at about 290 eV is assigned to Li₂CO₃, the peak around 288 eV is ascribed to C—O, and the broad peak at around 284-287 eV is actually a group of superimposed peaks including the C—C (graphite, sp2) at 284.4 eV, hydrocarbon (C—H) at 285 eV, and C—C—O at 286.5 eV. For the C1s peak of the EC and PC electrolytes, especially the EC electrolyte, more Li₂CO₃ and C—C—O/C—H compounds are present on the surface. It has been reported that more Li2CO₃ is good for improving the Li electrode cycleability. Meanwhile, few C—O (288 eV) bond of ROCO₂Li is found from the Li electrodes formed in EC and PC electrolytes, but the C—O bond of ROCO₂Li is majority in the SEI film on Li electrodes from DMC and EMC electrolytes.

It could be inferred from the intensity of the C1s data that some other organic compounds exist on the Li surface deposited in EC- and PC-based electrolytes.

FIG. 11B shows the O1s XPS spectra of the Li films deposited in the electrolytes with the four carbonate solvents. All the peaks are in the range from 529 eV to 535 eV. The Li₂CO₃ (532 eV) and LiOH (531.5 eV) are the main components in the SEI films on Li electrodes deposited from the four carbonate electrolytes. This is consistent with previously reported results. In the spectra for DMC and EMC samples, a small peak assigned to C—O—C of ROCO₂Li (533.5eV) is found. On the other hand, more Li₂CO₃ is present in the EC and PC samples, which is consistent with the C1s spectra.

The Li1s and F1s spectra of the four electrodes are shown in FIG. 11C and FIG. 11D, respectively. In Li1s, the main peaks are at about 55-56 eV. In this region, the possible substances include LiF (56 eV), Li2CO₃ (54.9 eV), and some other organic Li salts. All of them come from the decomposition of organic solvents and electrolyte salts on the surface of the deposited Li film. From the Li1s data, Li film deposited from EC electrolyte shows high Li₂CO₃ content as is revealed by C1s and O1s spectra. However, the Li film from PC electrolyte shows very high LiF content, which is also proven by the F1s spectra. This result is consistent with those reported in the literature.

In summary, XPS analysis indicates that more Li2CO3 was found in the SEI layer on the Li film deposited in EC-based electrolyte and more LiF was found in the SEI layer on the Li film deposited in PC-based electrolyte. Both Li2CO3 and LiF may improve the stability of SEI layers. As a result, Li films deposited in electrolytes based on PC and EC (both are cyclic carbonate solvents) demonstrate much better uniformity and coverage. LiF is a product of the decomposition of LiPF6 salt and/or the reactions between HF and Li compounds. The higher LiF content in the SEI layer on the Li film deposited in PC-based electrolyte is probably due to higher reactivity of PC with LiPF₆ than of other carbonate solvents, because the LiPF6-PC electrolyte changes color during storage even at room temperature while other LiPF₆-carbonate electrolytes remain colorless even for months. The reaction between PC and LiPF₆ may cause the decomposition of the salt to form LiF and may also generate HF that further reacts with the Li alkylcarbonate in the SEI layer on the Li electrode to form LiF.

Besides the inorganic compounds, more organic compounds are found on the Li electrode surfaces from the EC- and PC-based electrolytes. Without being tied to a particular theory, it is hypothesized that cyclic carbonate molecules tend to decompose through ring opening and consequently form longer chain semi-organic products, such as CH₃CH(OCO₂Li)CH₂OCO₂Li or (CH₂OCO₂Li)₂, which is good for the formation of a better SEI film on the Li electrode. This SEI layer is flexible and adheres well to the Li surface because of the long-chain organic components, and it can suppress non-uniform growth of the Li layer and sustain higher surface tension during the Li deposition process. Such a strong and flexible SEI layer favors easy growth of Li film and enhances its adhesion to the substrate. Compared to cyclic carbonates, the linear carbonate solvents were found not to form as good of a SEI layer; the deposition products of linear carbonates on Li metal are CH₃OCO₂Li or CH₃CH₂OCO₂Li, which are simpler and shorter than those of cyclic carbonates. With these short-chain products it is difficult to form a strong film to protect the Li metal. Consequently, Li deposited from a DMC- or EMC-based electrolyte can only cover a very limited amount of the substrate surface.

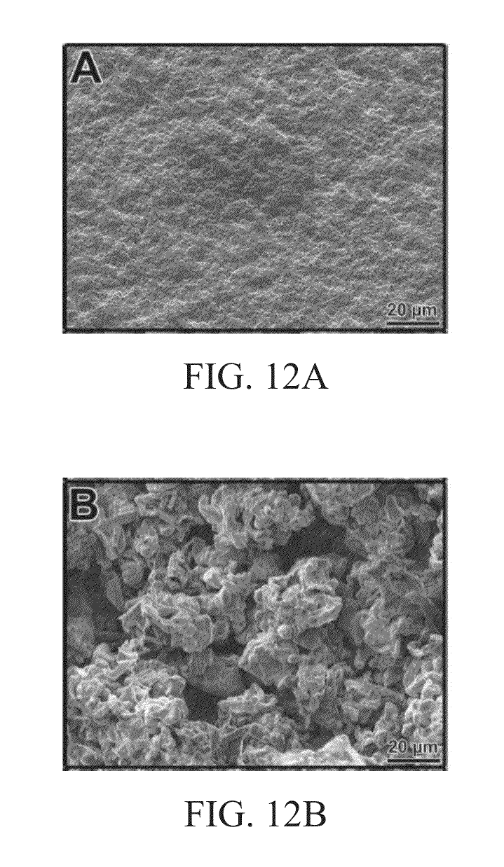

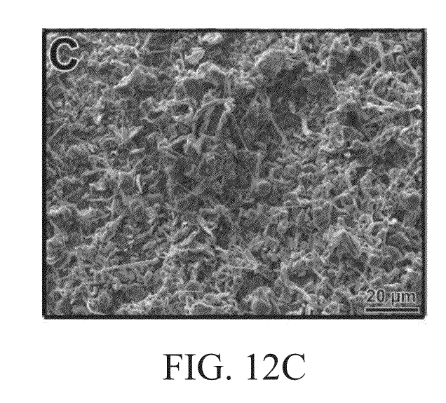

FIGS. 12A-12C show the morphologies of Li electrodes deposited from the electrolytes containing VC (A), FEC (B) and VEC (C) solvents with 1 M LiPF₆ salt. In the disclosed VC-based electrolyte composition, Li metal forms uniform and very small particles, and no apparent dendrites are formed (FIG. 12A). Without being tied to a particular theory, the inventors believe that dendrites may be suppressed by the SEI film formed in the disclosed VC electrolyte solution since the polymerization of VC on the Li surface greatly enhances the performance of the SEI film. In the disclosed FEC-based electrolytes, compact clusters of Li dendrite, similar to those of Li dendrites from EC- and PC-based electrolytes, are formed on Cu substrate as shown in FIG. 12B. However, it is also found that some areas of the Cu substrate are not fully covered by the deposited Li film using the disclosed FEC-based electrolyte compositions. Li morphology obtained in the disclosed VEC-based electrolyte embodiment (see FIG. 12C) was found to be very different from those obtained in certain of the disclosed VC- and FEC-based electrolyte embodiments. Needle-like clusters of Li dendrites appear to be formed and there is surprisingly superior coverage on the substrate than those obtained with certain embodiments of the disclosed FEC-based electrolytes.

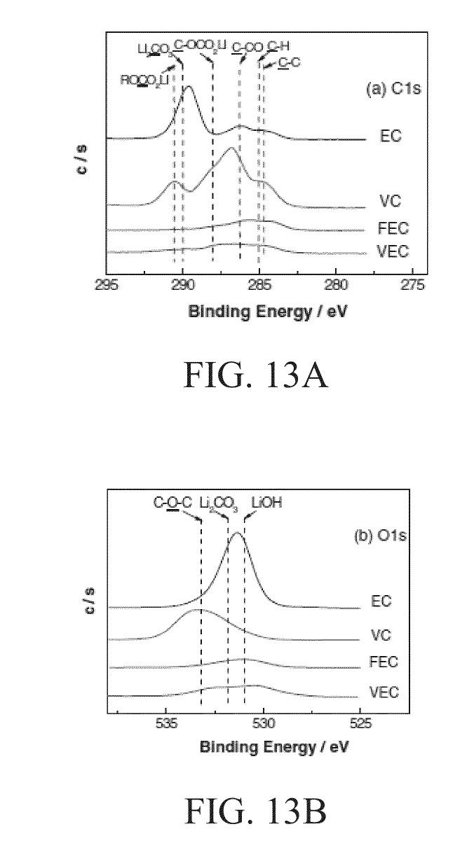

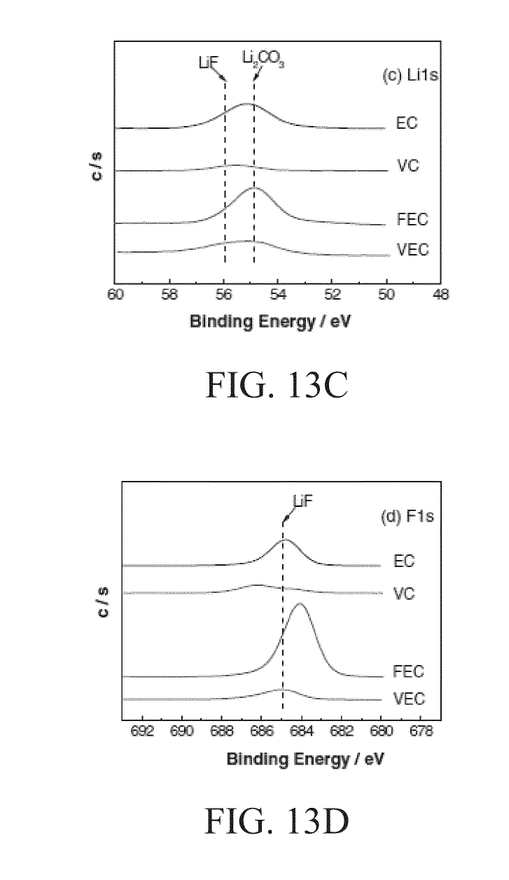

FIGS. 13A-D compare the XPS spectra of the surface films of the Li electrodes deposited in certain of the disclosed electrolyte embodiments comprising VC, FEC and VEC solvents along with an embodiment of an EC-based electrolyte. All electrolytes contained 1M LiPF₆ salt. As shown in its C1s and P1s spectra, the VC-based electrolyte embodiment results in more hydrocarbon (C—H) (285 eV), C—C—O (287 eV) and C—O—C of ROCO2Li (533.5 eV) substances than the EC-based electrolyte embodiment. The inventors also discovered from the O1s spectra of the Li electrode deposited in VC-based electrolyte embodiment that the Li₂CO₃/LiOH content decreased but the C—O band intensity increased.

In embodiments comprising FEC-based electrolyte solvents, as shown in the Li1s and F1s spectra (FIGS. 13C and 13D, respectively), the SEI layer of the Li electrode shows relatively high LiF content. SEI films with higher LiF and Li₂CO₃ compositions have been found to be more stable and favorable for long-term cycling stability of Li electrodes.

For the Li electrode deposited in embodiments of electrolytes comprising VEC-based solvents (see FIGS. 13A-B), the XPS spectrum for each element is flatter or smoother than the corresponding spectrum obtained for the Li electrode deposited using embodiments of electrolytes comprising EC-based solvent. The SEI film on the Li surface deposited in embodiments of electrolytes comprising VEC-based solvents, also exhibits much less Li₂CO₃ and fluorinated compounds than that deposited in embodiments of electrolytes comprising FEC-based solvents.

Embodiments of electrolytes comprising VC, FEC and VEC solvents, on the average CE of Li electrodes are compared in Table 2 above, along with embodiments of electrolytes comprising EC-based solvents. Apart from the electrolyte solvents, the electrolyte salt is another important factor that can greatly affect Li anode properties. Embodiments of the disclosed electrolytes comprising, inter alia, LiBOB, LiPF₆, LiAsF₆, LiTFSI, Lil, LiDFOB, LiBF₄, LiCF₃SO₃, and LiClO₄, were tested. LiBOB and LiDFOB show excellent ability to form good SEI layers on graphite anodes as well as being found to be advantageous salts in the electrolytes for Li electrodes in terms of morphology and CE.

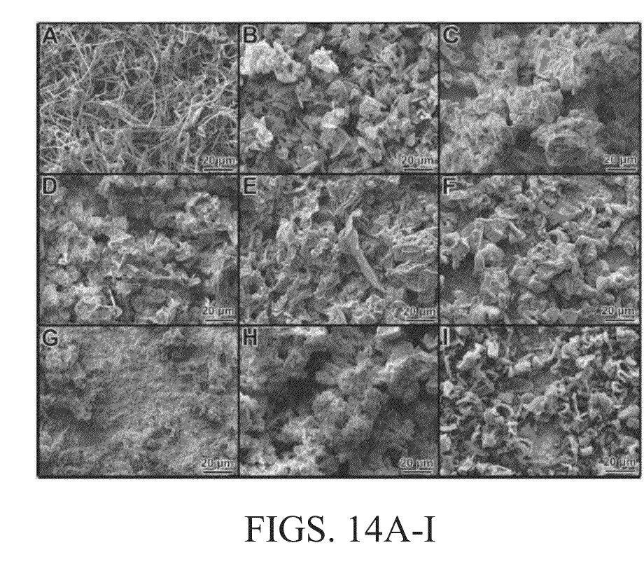

FIG. 14A to 14E show SEM images of Li films deposited in electrolytes containing 1 M of various Li salts (M1 salts) in PC solvent. PC was used as the solvent in the salt study because it enabled the best surface coverage when Li was deposited in the electrolytes containing different solvents (see FIG. 8). It is found that the anions have clear effects on Li deposition morphology. Excellent Li film morphology is obtained using the electrolyte embodiment comprising LiBOB salt, as shown in FIG. 14A. The Li surface is fibrous rather than the dendritic clusters. In addition to the capability of forming a stable SEI layer quickly, the surface tension of these embodiments of the disclosed electrolytes may also play a key role in the morphology of Li films deposited in these electrolytes. Li could form a compact film to cover the Cu substrate when it was deposited using embodiments of the disclosed electrolytes comprising salts of LiBOB, LiPF₆, LiAsF₆, LiTFSI, and Lil, as shown in FIGS. 14A to 14E, respectively. LiBOB forms a good SEI layer to protect a graphite anode. LiPF₆ leads to the formation of LiF that is beneficial for a smooth Li morphology. LiAsF₆ is more stable with the Li electrode and results in a better surface chemistry. Li deposited in the electrolytes comprising LiDFOB, LiBF₄, LiCF₃SO₃, and LiClO₄ salts do not cover the substrate as well as other embodiments, as shown in FIGS. 12F to 12I, respectively.

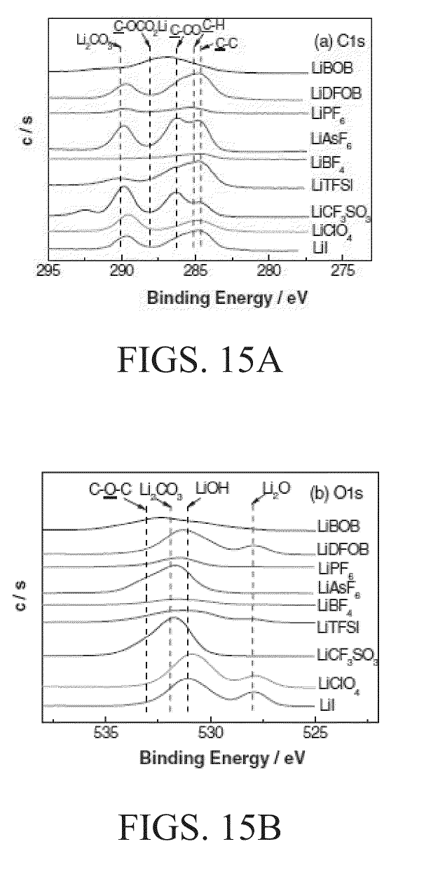

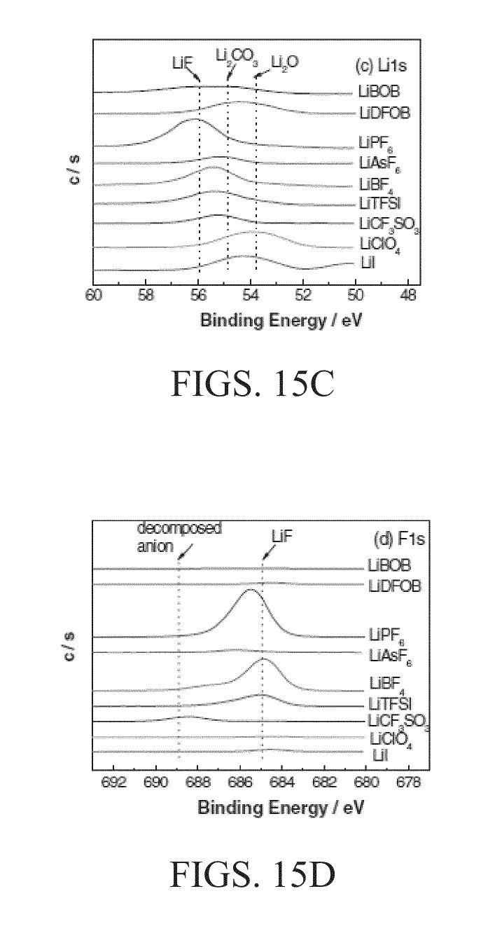

FIGS. 15A-D show XPS spectra of Li films deposited in certain embodiments of electrolytes comprising different Li salts. LiBOB results in a flat bump assigned to different carbon compounds. LiBF4 shows the weakest carbon signal. Other Li salts exhibit similar spectra assigned to Li₂CO3 and other carbon compounds. The O1s spectra show that Li₂CO₃ and LiOH are the most important oxygen compounds in the SEI films. In the SEI films from electrolytes based on LiDFOB, LiClO₄ and Lil, Li₂O is found. The formed Li₂O may react with the electrolyte gradually. The Li1s spectra show that LiF is the main Li compound in electrolytes based on LiPF₆, LiBF₄ and LiTFSI, which is also proven by the F1s spectra.

Influences of electrolyte embodiments comprising different salts on the average CEs of Li electrodes are shown in Table 6. The average CE varies with different salts used in the electrolytes.

In addition to the high CE (95.2%) of the electrolyte comprising LiAsF6, electrolytes comprising LiBOB and LiDFOB also lead to higher CEs of 92.5% and 85.7%, respectively. A lower CE means more non-faradaic reactions on the Li electrode surface. For electrolyte embodiments comprising LiAsF₆, the higher CE could come from the formation of AsF₃ by the reduction of the salt during the first cycle, after which the formed AsF₃ prevents further reactions of the Li electrode with electrolyte components.

TABLE 6
Average Coulombic efficiencies

| | Average Li Coulombic |
|---|---|
| Li salt | efficiency |
| LiPF₆ | 76.5% |
| LiBF₄ | 71.9% |
| LiAsF₆ | 95.2% |
| LiTFSI | 72.3% |
| LiCF₃SO₃ | 73.4% |
| LiClCO₄ | 72.1% |
| LiBOB | 92.5% |
| LiDFOB | 85.7% |
| LiI | 68.9% |

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

1. An electrolyte solution for electrodeposition of a first metal (M1) on a substrate, the electrolyte solution comprising:
one or more M1 reactants, the reactants comprising cations of M1;
a soluble, surface-smoothing additive comprising cations of a second metal (M2), wherein cations of M2 have an effective electrochemical reduction potential in the solution lower than that of the cations of M1; an aprotic organic solvent a mixture; and
a solid electrolyte interphase (SEI) film formation additive.

2. The electrolyte solution of claim 1, wherein M1 comprises lithium.

3. The electrolyte solution of claim 1, wherein the solvent is selected from the group consisting of carbonates, ethers, phosphates, carboxylates, lactones, sulfones, sulfoxides, nitriles, amides, and mixtures thereof.

4. The electrolyte solution of claim 1, wherein the solvent comprises ethylene carbonate (EC), propylene carbonate (PC), dimethyl carbonate (DMC), ethyl methyl carbonate (EMC), diethyl carbonate (DEC), vinylene carbonate (VC), fluorethylene carbonate (FEC), 4-vinyl-1,3-dioxlan-2-one (VEC), 1,2-dimethoxyethane (DME), 1,3-dioxlane (DOL), dimethyl sulfone, ethyl methyl sulfone, methyl butyrate, ethyl propionate, trimethyl phosphate, gamma-butyrolactone, 4-methylene-1,3-dioxlan-2-one (4-methyleneethylene carbonate, MEC), 4,5-dimethylene-1,3-dioxlan-2-one, allyl ether, triallyl amine, triallyl cyanurate, triallyl isocyanurate, or a mixture thereof.

5. The electrolyte solution of claim 1, wherein the cations of M2 comprise a metal cation selected from the group consisting of cations of Cs, Rb, Ba, Sr, Ca, Li, or a combination thereof.

6. The electrolyte solution of claim 2, wherein M2 comprises Cs.

7. The electrolyte solution of claim 1, wherein the surface-smoothing additive further comprises an anion selected the group consisting of PF₆⁻, AsF₆⁻, BF₄⁻, N(SO₂CF₃)₂⁻, N(SO₂F)₂₋, CF₃SO₃⁻, ClO₄⁻, bis(oxalate)borate anion (BOB⁻), difluoro oxalato borate anion (DFOB⁻), I⁻, Br⁻, Cl⁻, OH⁻, NO₃⁻, SO₄²⁻, and combinations thereof.

8. The electrolyte solution of claim 1, wherein the SEI formation additive comprises VC, FEC, VEC, MEC, allyl ether, triallyl amine, tribally cyanurate, tribally isocyanurate, LiAsF₆, LiBOB, LiDFOB, or mixtures thereof.

9. The electrolyte solution of claim 1 further comprising an M1 salt selected from the group consisting of LiPF₆, LiBF₄, LiAsF₆, LiBOB, LiDFOB, LiTFSI, LiClO₄, or a combination thereof.

10. The electrolyte solution of claim 9, wherein the surface-smoothing additive is present in a concentration of from 0-50% by mole of an M1 salt concentration.

11. The electrolyte solution of claim 9, wherein the surface-smoothing additive is present in a concentration of from about 2-30% by mole of an M1 salt concentration.

12. The electrolyte solution of claim 1, further comprising a concentration of the SEI formation additive of about 0.01-10% by weight in the electrolyte solution.

13. The electrolyte solution of claim 1, further comprising a concentration of the SEI formation additive of about 0.5-5% by weight in the electrolyte solution.

14. The electrolyte solution of claim 1, wherein the cations of M2 are not chemically or electrochemically reactive with respect to M1 or the cations of M1.

15. The electrolyte solution of claim 9, wherein M2 is 0 to 20 mol % of M1, with x wt % of VC and y wt % of LiAsF₆, where x=0.1 to 10, y=0 to 20.

16. The electrolyte solution of claim 1, wherein the substrate is an electrode.

17. The electrolyte solution of claim 16, wherein the electrode comprises carbon.

18. The electrolyte solution of claim 16, wherein the electrode is an electrode in an energy storage device.

19. An electrolyte solution comprising:
a solvent selected from a group consisting of EC, PC, DMC, EMC, DEC, VC, FEC, VEC, DME, DOL, and mixtures thereof;
a lithium salt selected from a group consisting of LiPF₆, LiAsF₆, LiBF₄, LiTFSI, LiClO₄, LiBOB, LiDFOB, and mixtures thereof;
a surface-smoothing additive selected from a group consisting of CsPF₆, RbPF₆, CsAsF₆, RbAsF₆, and mixtures thereof; and
an SEI formation additive selected from a group consisting of VC, FEC, VEC, MEC, allyl ether, triallyl amine, tribally cyanurate, tribally isocyanurate, LiAsF₆, LiBOB, LiDFOB, and mixtures thereof.

20. The electrolyte solution of claim 19, wherein the surface-smoothing additives are present in a concentration of from about 0-30% by mole of the lithium salt concentration.

21. The electrolyte solution of claim 19, wherein the surface-smoothing additives are present in a concentration of from about 5% by mole of the lithium salt concentration.

22. The electrolyte solution of claim 19, further comprising a concentration of the SEI formation additive of about 0.1-10% by weight in the electrolyte solution.

23. The electrolyte solution of claim 19, further comprising a concentration of the SEI formation additive of about 0.5-5% by weight in the electrolyte solution.

24. The electrolyte solution of claim 19, wherein, the lithium salt comprises about 1.0M LiPF₆, the solvent comprises EC-EMC at 3:7 by volume, the surface-smoothing additive comprises about 0.05M CsPF₆ and the SEI formation additives comprise about 2 wt % LiAsF₆ and 2 wt % VC or FEC.

25. An electrolyte solution comprising:
a solvent selected from a group consisting of PC, EC-PC, EC-PC-DMC, or EC-PC-EMC, or EC-PC-DMC-EMC;
a lithium salt comprising LiPF₆;
a surface-smoothing additive comprising CsPF₆; and
an SEI formation additive selected from a group consisting of VC, FEC, MEC, LiAsF₆, and mixtures thereof.

26. The electrolyte solution of claim 25, wherein concentrations are about 1.0M LiPF₆ in EC-PC-EMC at 5:2:3 by weight, about 0.05M CsPF₆, about 2 wt % LiAsF₆, and about 2 wt % VC or FEC.
